(19) United States
(12) Patent Application Publication
(10) Pub. No.: US 2025/0317818 A1
(43) Pub. Date: Oct. 9, 2025

(54) UE-Triggered Mobility-Based Handling of Security Keys in Inter-CU LTM

(71) Applicant: Apple Inc., Cupertino, CA (US)

(72) Inventors: Naveen Kumar R PALLE VENKATA, San Diego, CA (US); Fangli XU, Beijing (CN); Haijing HU, San Jose, CA (US); Shu GUO, Beijing (CN); Yuqin CHEN, Beijing (CN)

(21) Appl. No.: 19/170,406

(22) Filed: Apr. 4, 2025

Related U.S. Application Data
(60) Provisional application No. 63/574,405, filed on Apr. 4, 2024.

(51) Int. Cl. H04W 36/04; H04W 12/0431

(52) U.S. Cl. CPC H04W 36/04; H04W 12/0431

(57) ABSTRACT

An apparatus configured to process, based on signaling received from a first serving cell, a configuration for candidate cells for conditional lower layer triggered mobility (LTM) and a first next hop chaining counter (NCC) value to be used for a first conditional LTM switch, trigger the first conditional LTM switch to a second serving cell when channel measurements on a second serving cell satisfy a set of handover conditions, derive a first security key for communications with the second serving cell based on a previous key used for communications with the first serving cell and the first NCC value, select a second NCC value for deriving a second security key for a second conditional LTM switch after the first conditional LTM switch is completed and generate, for transmission to the second serving cell, a message comprising the second NCC value.

### PRIORITY/INCORPORATION BY REFERENCE

This application claims priority to U.S. Provisional Application Ser. No. 63/574, 405 filed on Apr. 4, 2024, and entitled “UE-triggered Mobility-based Handling of Security Keys in Inter-CU LTM,” the entirety of which is incorporated by reference herein.

### BACKGROUND

New Radio (NR) supports multiple different types of handovers to change a serving cell for a user equipment (UE). In Rel-18, lower layer triggered mobility (LTM) was introduced to support a serving cell change via layer 1 (L1) or layer 2 (L2) signaling. In some LTM use cases, a L2 medium access control (MAC) control element (MAC-CE) may trigger the handover.

In Rel-18, LTM is limited to scenarios where a centralized unit (CU) of the source cell and the target cell remains the same (intra-CU handover). Thus, there is no change in security keys for the UE to communicate with the target cell. However, it is an objective to support inter-CU LTM, which requires the exchange of security-related information so that the security key FOR THE TARGET CELL MAY BE DERIVED BY THE UE.

### SUMMARY

Some example embodiments are related to an apparatus having processing circuitry configured to process, based on signaling received from a first serving cell, a configuration for candidate cells for conditional lower layer triggered mobility (LTM) and a first next hop chaining counter (NCC) value to be used for a first conditional LTM switch, trigger the first conditional LTM switch to a second serving cell when channel measurements on a second serving cell satisfy a set of handover conditions, derive a first security key for communications with the second serving cell based on a previous key used for communications with the first serving cell and the first NCC value, select a second NCC value for deriving a second security key for a second conditional LTM switch after the first conditional LTM switch is completed and generate, for transmission to the second serving cell, a message comprising the second NCC value.

Other example embodiments are related to an apparatus having processing circuitry configured to derive a first security key for communications with a user equipment (UE) based on a first intermediate security key derived by a first serving cell and a first next hop chaining counter (NCC) value, the first security key to be used for a first conditional lower layer triggered mobility (LTM) switch of the UE, process signaling from the UE for the first conditional LTM switch, the signaling including a second NCC value used to derive a second security key for a second conditional LTM switch after the first conditional LTM switch is completed and generate, for transmission to an access and mobility function (AMF) of a radio network, a message comprising the second NCC value.

Still further example embodiments are related to an apparatus having processing circuitry configured to process, based on signaling received from a first serving cell, a configuration for candidate cells for conditional lower layer triggered mobility (LTM) and a first list of next hop chaining counter (NCC) values to be used for conditional LTM switches, trigger a first conditional LTM switch to a second serving cell when channel measurements on the second serving cell satisfy a set of handover conditions, derive a first security key for communications with the second serving cell based on a previous security key used for communications with the first serving cell and a first NCC value included in the first list of NCC values and complete the first conditional LTM switch to the second serving cell.

Additional example embodiments are related to an apparatus having processing circuitry configured to process signaling from an access and mobility function (AMF) of a radio network including a first list of next hop chaining counter (NCC) values to be used for conditional lower layer triggered mobility (LTM) switches by a user equipment (UE), distribute a first intermediate security key and a first NCC value from the first list to one or more candidate cells for deriving a first security key for a first conditional LTM switch and generate, for transmission to the UE, a message comprising the first list.

### BRIEF DESCRIPTION OF THE DRAWINGS

FIG. 1 shows an example signaling diagram for handover from a first cell supported by a first centralized unit (CU) to a second cell supported by a second centralized unit (inter-CU handover), the handover being triggered by a user equipment (UE) in a lower layer triggered mobility (LTM) operation, the UE selecting a counter value (NCC) to use for a subsequent handover, according to various example embodiments.

FIG. 2 shows an example signaling diagram for handover from a first cell supported by a first CU to a second cell supported by a second CU (inter-CU handover), the handover being triggered by a UE in a LTM operation, the UE using a NCC value for handover based on a configured list of NCC values, according to various example embodiments.

FIG. 3 shows an example signaling diagram for handover from a first cell supported by a first CU to a second cell supported by a second CU (inter-CU handover), the handover being triggered by a UE in a LTM operation, the UE using a NCC value for a handover based on a configured list of NCC values and providing the next NCC value to the AMF, according to various example embodiments.

FIG. 4 shows an example signaling diagram for handover from a first cell supported by a first CU to a second cell supported by a second CU (inter-CU handover), the handover being triggered by a UE in a LTM operation, the access and mobility function (AMF) determining to re-initialize the security handling, according to various example embodiments.

FIG. 5a shows a LTM configuration IE including a first new IE for UE-triggered LTM according to one example of these example embodiments.

FIG. 5b shows the UE-triggered LTM IE of FIG. 5a including a second new IE for a NCC list configuration according to one example of these example embodiments.

FIG. 5c shows the NCC list configuration IE of FIG. 5b including a third new IE for a NCC list.

FIG. 6 shows a RRC reconfiguration complete IE including a new IE for a selected NCC according to one example of these example embodiments.

FIG. 7 shows an example network arrangement according to various example embodiments.

FIG. 8 shows an example user equipment (UE) according to various example embodiments.

FIG. 9 shows an example base station according to various example embodiments.

### DETAILED DESCRIPTION

The example embodiments may be further understood with reference to the following description and the related appended drawings, wherein like elements are provided with the same reference numerals. The example embodiments relate to security handling for lower layer triggered mobility (LTM) operations in which a user equipment (UE) triggers a handover from a source cell provided by a first centralized unit (CU) to a target cell provided by a second CU, e.g., inter-CU LTM. In particular, the example embodiments relate to scenarios in which conditional LTM is configured for the UE and the UE is enabled to initiate multiple inter-CU serving cell switches (e.g., trigger an initial inter-CU serving cell switch from a first source cell to a first target cell, trigger a subsequent inter-CU serving cell switch from a second source cell (previous first target cell) to a second target cell, etc.) without receiving any updated security information for performing the switches.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing handover functionalities similar to those described herein. Therefore, the 5G NR network as described herein may represent any type of network implementing functionalities similar to the 5G NR network, e.g., 5G-Advanced networks, 6G networks, etc.

The example embodiments are further described with regard to a handover (HO). A traditional handover may be initiated by a UE or by a serving cell. In UE-initiated HO, the UE may evaluate various predefined conditions in view of its RRM measurements and, when the conditions are met, may request a HO. The serving cell receiving the HO request may evaluate whether a handover should be performed for the UE based on various potential factors and, if it is determined that a handover should be performed, initiate the handover process. In network-initiated HO, the serving cell may determine the handover should be performed without first receiving the UE request, e.g., for purposes such as load balancing or radio resource optimization. The serving cell (source cell) may select a target cell and the target cell may be prepared for HO of the UE. The serving cell may then transmit a handover command to the UE via radio resource control (RRC) reconfiguration and provide parameters for the target cell so that the UE may switch to the target cell without significant interruption to the network connection, e.g., without requiring an RRC reestablishment procedure.

The example embodiments are further described with regard to conditional handover (CHO). Conditional handover (CHO) relates to operations in which the network provides the UE a list of one or more target cell(s) for CHO with a corresponding configuration for these target cell(s), which are prepared for handover in advance of the actual handover. For each target cell, the source gNB provides at least one condition for the UE to perform CHO. The condition(s) may relate to a radio quality for the source cell and/or the target cell as determined by the UE, e.g., whether the radio conditions on the current serving cell fall below a threshold RSRP/RSRQ/SINR, determine whether the radio conditions of a neighbor cell meet a threshold RSRP/RSRQ/SINR, and/or whether a differential between the radio conditions on the serving cell and the neighbor cell meet a threshold RSRP/RSRQ/SINR. The UE performs measurements on the serving/target cells and, when the condition is satisfied for a target cell, the UE starts CHO and applies the preconfigured target cell configuration immediately. With CHO, the UE is able to execute the handover process without the involvement of the source cell, e.g., even when a radio quality of the connection with the source cell has degraded such that a source cell-initiated handover is not possible.

A handover may be performed within a same centralized unit (CU) (intra-CU handover) or across different CUs (inter-CU handover). A CU supports higher layers of the 5G protocol stack, e.g., service data adaptation protocol (SDAP), packet data convergence protocol (PDCP) and radio resource control (RRC) while a distributed unit (DU) supports lower layers of the 5G protocol stack, e.g., radio link control (RLC), medium access control (MAC) and the physical layer (PHY). One CU may control the respective DUs of multiple base stations, e.g., gNBs.

In an intra-CU handover, there is no change in security keys for the UE to communicate with the target cell. In an inter-CU handover, security-related information may be exchanged so that the security key for the target cell may be derived by the UE.

The security key is managed by the access and mobility management function (AMF) of the core network and the UE. When a UE switches between CUs, an updated security key is derived. The handover dynamics may be designed to limit the ability of a network node to know security keys for other network nodes. An initial key (KgNB) is derived by the AMF and provided to a first node of a first CU (source node). During handover, the source node provides the current UE security capabilities and a new key (Kng-ran*) to a second node of a second CU (target node). The new key is derived by the source node for the target node.

The new key for the target node may be derived using either a horizontal derivation or a vertical derivation. For a horizontal derivation, the new key may be derived from the previous key, a next hop (NH) parameter, a physical cell ID (PCI) and a DL frequency (ARFCN-DL). For a vertical derivation, the new key may be derived from the previous key and a NH/next hop chaining counter parameter (NCC) pair. The UE derives a new security key based on the NCC. If the NCC is the same, then horizontal key derivation may be used. If the NCC is different, the UE may derive the NH until the NCC matches (with each increment). After the handover is complete, the target network node informs the AMF of the handover with a PATH SWITCH complete message. The AMF creates a fresh set of NH/NCC. The AMF provides the new NH/NCC to the target network node.

One of the aims of introducing the NH/NCC pairs is to disallow forward security key derivation. The source provides the KgNB to the target, thus, the source is aware of the keys used by the target. To disallow the tracking (or the ability) of the source to know the keys used by the UE through its mobility the NH is introduced, where the gNB cannot derive (and is not aware) of the NH of the other gNBs for a particular UE. Both the NH and KgNB are used to derive the Kng-ran (using PCI and ARFCN and other parameters), but the NH is known only at the UE and the AMF. The AMF distributes the NH to gNBs.

To derive the Kng-ran*, the previous KgNB or NH is needed. If NH is used, then NCC is needed (and incremented after every use by the AMF and the UE in sync). The NCC is used to track the number of KgNB derivations based on the NH. The NCC is also used by the UE to know whether horizontal or vertical derivation is to be performed at the UE. Otherwise, the UE is not aware (does not care) about how the gNB handles the Kng-ran*.

As described above, a handover may be triggered by layer 3 (L3) measurements and is performed via radio resource control (RRC) signaling. The L3 handover may cause reconfiguration of upper layers (e.g., RRC or PDCP) and/or resetting of lower layers (e.g., PHY or MAC).

Lower layer triggered mobility (LTM) was introduced in Rel-18 to support a serving cell change via L1 or L2 signaling. In LTM, a reconfiguration of upper layers is not required and minimal changes are made to the configuration of the lower layers, thus reducing the latency and overhead of the handover process.

In Rel-18, a LTM switch may be triggered by a L2 MAC-CE. The LTM switch of Rel-18 is only for intra-CU. Because the CU remains the same, there is no change in security keys or context and no change in PDCP. The LTM switch may be inter-DU (RLC and MAC reset) or intra-DU (MAC reset alone). The UE confirms the L2 trigger with a L3 RRC message (RRCReconfigComplete). No RRC messages to the UE are expected between LTM cell switches, even for subsequent LTM switches.

In Rel-19, it is an objective to support UE-triggered inter-centralized unit (CU) LTM. In particular, it is an objective to support conditional inter-CU LTM switches including subsequent conditional inter-CU LTM switches. In this handover case, the UE evaluates handover conditions and initiates the handover. Handover conditions may comprise a set of handover conditions. A set of handover conditions may comprise . . . [can we provide a couple examples here to better support the claims?] Thus, there is no network input (e.g., MAC-CE) at the time of switch. Accordingly, the UE cannot be provided a new security key (or security key-related information) at the time of the switch.

Accordingly, solutions should be devised such that the security requirements are met for UE-initiated inter-CU LTM switches without RRC or MAC-CE messages from the network.

According to various example embodiments, operations are described for security handling for an inter-CU handover with a UE-initiated LTM trigger.

In one aspect of these example embodiments, the UE may be provided an initial NCC to use for a first inter-CU LTM switch and, when the UE initiates the first inter-CU LTM switch, the UE may use the initial NCC to derive the security key for communications with the first target cell and may additionally select and provide a next NCC to be used for a second inter-CU LTM switch to a second target cell. The UE may continue to select and provide the next NCC for subsequent switches.

In these example embodiments, the first NCC to be used for deriving security keys in a LTM switch is provided to the UE via RRC at the time of the LTM candidate configuration. After initiating the inter-CU LTM switch to a target cell, the UE may provide the target cell with a selected NCC (a “next” NCC for a subsequent inter-CU LTM switch), e.g., in a RRC reconfiguration complete message upon connection establishment. After the switch, the current source cell (previous target cell) may provide the AMF with the selected NCC, e.g., in a path switch complete message. Thus, the three entities that need to know the “next” NCC for a subsequent inter-CU LTM switch are informed of this NCC.

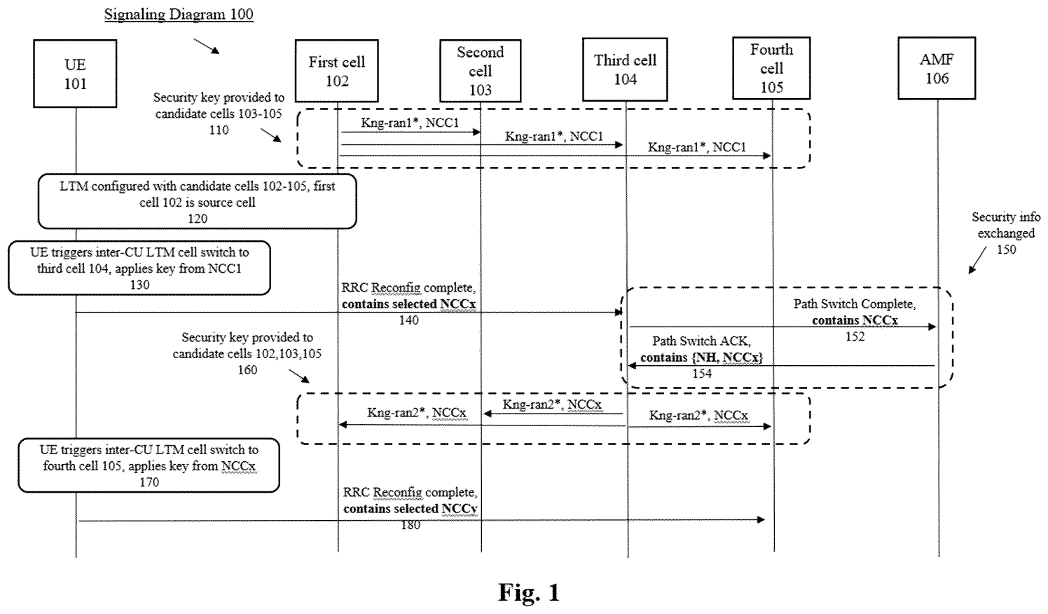

FIG. 1 shows an example signaling diagram 100 for handover from a first cell supported by a first centralized unit (CU) to a second cell supported by a second centralized unit (inter-CU handover), the handover being triggered by a user equipment (UE) in a lower layer triggered mobility (LTM) operation, the UE selecting a counter value (NCC) to use for a subsequent handover, according to various example embodiments. The signaling diagram 100 is described with regard to security handling for conditional LTM (UE-initiated LTM) with subsequent conditional LTM, e.g., multiple switches without RRC or MAC-CE. The signaling diagram 100 includes a UE 101, a first cell 102, a second cell 103, a third cell 104, a fourth cell 105, and the AMF 106. In this example, the first cell 102 is a current serving cell of the UE 101 and comprises an initial source cell for LTM.

In 110, the first cell 102 distributes security keys to the second cell 103, the third cell 104 and the fourth cell 105 for a UE-initiated LTM switch. The security keys are derived from a NH/NCC pair provided to the first cell 102 by the AMF 106. In this example, the NCC in the NH/NCC pair is NCC1. The first cell 102 derives a single security key, Kng-ran1* from the previous key and NH/NCC1 that may be distributed to all of the cells 103-105 along with the NCC1 in a pre-configuration of the cells 103-105 as candidate target cells for an LTM switch by the UE 101. The NH is not distributed. Thus, the cells 103-105 are configured as candidate cells for LTM and possess the “to be used next” Kng-ran* key. When the UE selects one of these cells 103-105 for handover, the selected cell will derive the KgNB from the Kng-ran* and the NCC1.

In 120, the first cell 102 configures LTM for the UE 101. The UE 101 is provided with NCC1 for deriving the security key for a target candidate cell. The UE 101 may be provided with a list of candidate cells for LTM including the first cell 102, the second cell 103, the third cell 104 and the fourth cell 104. Although the first cell 102 is the current serving cell (source cell), the LTM configuration includes the first cell 102 as a candidate cell in anticipation of multiple cell switches, e.g., the first cell 102 may become a candidate cell for a subsequent LTM switch after an initial LTM switch from the first cell 102 to one of the other cells 103-105.

In 130, the UE 101 triggers a first inter-CU LTM cell switch. In this example, the UE 101 triggers the switch to the third cell 104 that satisfied conditional handover conditions. The UE 101 derives the security key for the third cell 104 based on the NCC1 and applies the configuration for the third cell 104.

In 140, the UE 101 provides a selected NCC to the third cell 104. The UE 101 selects the NCC to be used for a subsequent LTM switch (the “next” switch). In this example, the selected NCC is referred to as NCCx. The selected NCCx may be provided to the third cell 104 from the UE 101 in a RRC reconfiguration complete message that concludes the first inter-CU LTM switch, e.g., as shown in the example RRC Reconfiguration Complete IE 600 of FIG. 6.

In 150, the third cell 104 completes the path switch with the AMF 106 and exchanges security information for the next switch. In 152, the third cell 104 transmits a path switch complete message to the AMF 106 to inform the AMF 106 of the LTM switch and includes in the message the NCCx selected by the UE 101. In 154, the third cell 104 receives from the AMF 106 a path switch acknowledgment message including a new NH/NCC pair for deriving the security keys for the next switch, the NH/NCC pair including the NCCx and an associated NH that is based on the NCCx. The third cell 104 may now act as the source cell for a subsequent LTM switch by the UE 101.

In 160, the third cell 104 distributes security keys to the first cell 102, the second cell 103, and fourth cell 105 for a subsequent UE-initiated LTM switch, similar to 110. The security keys are derived from {NH, NCCx} provided to the third cell 104 from the AMF 106. The third cell 104 derives a single security key, Kng-ran2* from the previous key and NH/NCCx that may be distributed to all of the cells 102, 103, 105 along with the NCCx. The NH is not distributed. Thus, the cells 102, 103, 105 are configured as candidate cells for LTM and possess the “to be used next” Kng-ran* key. When the UE selects one of these cells 102, 103, 105 for handover, the selected cell will use that key.

In 170, the UE 101 triggers a second inter-CU LTM cell switch, similar to 130. In this example, the UE 101 triggers the switch to the fourth cell 105 that satisfied conditional handover conditions. The UE 101 derives the security key for the fourth cell 104 based on the NCCx and applies the configuration for the fourth cell 105.

In 180, the UE 101 provides a selected NCC to the fourth cell 105, similar to 140. The UE 101 selects the NCC to be used for a subsequent LTM switch (the “next” switch). In this example, the selected NCC is referred to as NCCy. The selected NCCy may be provided to the fourth cell 104 from the UE 101 in a RRC reconfiguration complete message that concludes the second inter-CU LTM switch.

The fourth cell 104 may provide the NCCy to the AMF 106 and receive a NH associated with the NCCy during the completion of the path switch. The process may continue for any number of LTM switches, with the UE 101 selecting a new NCC for each subsequent LTM switch.

In these example embodiments, the UE selects the NCC, as opposed to having the AMF choosing the NCC (e.g., as in legacy operations). The UE selection of NCC allows all three actors (UE, gNB and AMF) to be in sync with the next key to be used. The gNBs are not able to know the NH of other gNBs, thus, the security requirements are maintained. To implement these embodiments, there may be interface changes between gNB and AMF (N2 interface), and gNB-gNB (Xn interface), along with RRC changes in Uu interface.

In another aspect of these example embodiments, the UE may be provided with a list of NCCs to use for multiple inter-CU LTM switches and may use the NCCs in order for each successive switch. In other words, the UE uses the first NCC in the list for a first inter-CU LTM switch, uses the second NCC in the list for a second inter-CU LTM switch, etc.

In these example embodiments, the UE receives the list from the AMF via the current serving cell. The current serving cell may include the list in the RRC LTM configuration (protected). Relative to the embodiments described above, these embodiments avoid the UE selecting the NCC. Instead, the AMF provides a list of NCCs the UE should use, and in the order the UE should use. With the AMF guiding the UE, both the AMF and the UE are in sync with what NCC is to be used. In these embodiments, gNBs are potentially prevented from trying to get the NH based on NCC.

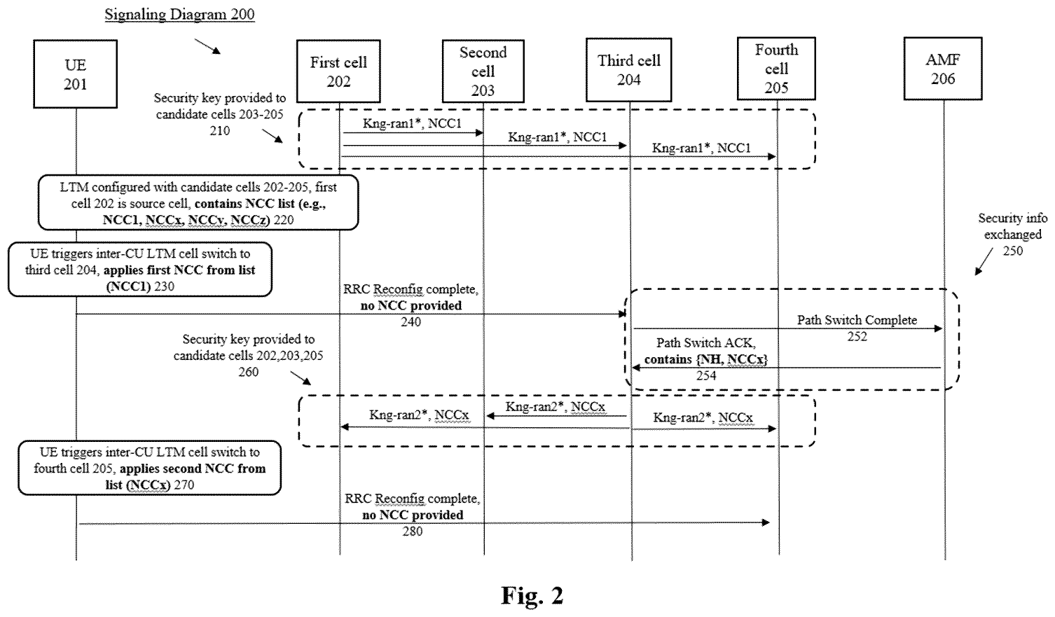

FIG. 2 shows an example signaling diagram 200 for handover from a first cell supported by a first CU to a second cell supported by a second CU (inter-CU handover), the handover being triggered by a UE in a LTM operation, the UE using a NCC value for handover based on a configured list of NCC values, according to various example embodiments. Similar to the signaling diagram 100 of FIG. 1, the signaling diagram 200 is described with regard to security handling for conditional LTM (UE-initiated LTM) with subsequent conditional LTM, e.g., multiple switches without RRC or MAC-CE. The signaling diagram 200 includes a UE 201, a first cell 202, a second cell 203, a third cell 204, a fourth cell 205, and the AMF 206. The first cell 202 is a current serving cell of the UE 201 and comprises an initial source cell for LTM.

In 210, the first cell 202 distributes security keys to the second cell 203, the third cell 204 and the fourth cell 205 for a UE-initiated LTM switch, similar to 110 of FIG. 1. The security keys are derived from {NH, NCC1} provided to the first cell 202 from the AMF 206. Similar to 110, the first cell 202 derives a single security key, Kng-ran1*, from the previous key and NH/NCC1 that may be distributed to all of the cells 203-205 along with the NCC1 in a pre-configuration of the cells 203-205 as candidate target cells for an LTM switch by the UE 201. The NH is not distributed.

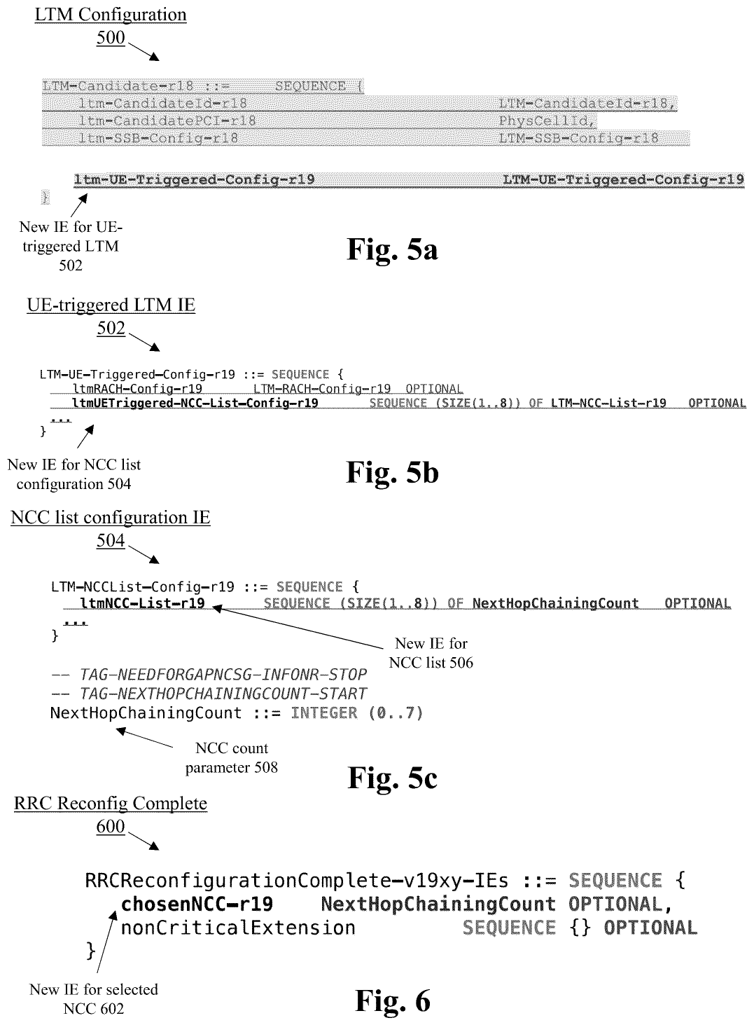

In 220, the first cell 202 configures LTM for the UE 201 including the list of candidate cells for LTM (cells 202-205) and a list of NCCs provided to the first cell 202 by the AMF 206, e.g., as shown in the example LTM configuration IEs of FIGS. 5a-c. In one example, the list of NCCs may include four entries, e.g., (NCC1, NCCx, NCCy, NCCz). The UE 201 may derive the security key for a target candidate cell based on the NCCs included in the list in sequential order.

In 230, the UE 201 triggers a first inter-CU LTM cell switch. In this example, the UE 201 triggers the switch to the third cell 204 that satisfied conditional handover conditions. The UE 201 derives the security key for the third cell 204 based on the first NCC entry in the list (NCC1) and applies the configuration for the third cell 204.

In 240, the UE 201 transmits a RRC reconfiguration complete message that concludes the first inter-CU LTM switch. In these example embodiments, the UE 201 does not include any NCC value in the message. For the next switch, the UE 201 will use the second NCC in the list, e.g., NCCx. The AMF 206 is already aware of the next NCC that will be used.

In 250, the third cell 204 completes the path switch with the AMF 206 and exchanges security information for the next switch. In these embodiments, the third cell 204 does not include any NCC value in the message for a next switch (the AMF 206 is already aware of this value). In 252, the third cell 204 transmits a path switch complete message to the AMF 206 to inform the AMF 206 of the LTM switch. In 254, the third cell 204 receives from the AMF 206 a path switch acknowledgment message including a new NH/NCC pair for deriving the security keys for the next switch. The NCC included in the pair is the next NCC on the list, e.g., NCCx. The associated NH is based on the NCCx. The third cell 204 may now act as the source cell for a subsequent LTM switch by the UE 201.

In 260, the third cell 204 distributes security keys to the cells 202, 203, 205 for a subsequent UE-initiated LTM switch, similar to 210. The security keys are derived from {NH, NCCx} provided to the third cell 204 from the AMF 206. The third cell 204 derives a single security key, Kng-ran2* from the previous key and NH/NCCx that may be distributed to all of the cells 202, 203, 205 along with the NCCx. The NH is not distributed.

In 270, the UE 201 triggers a second inter-CU LTM cell switch, similar to 230. In this example, the UE 201 triggers the switch to the fourth cell 205 that satisfied the conditional handover conditions. The UE 201 derives the security key for the fourth cell 204 based on the NCCx and applies the configuration for the fourth cell 205.

In 280, the UE 201 transmits a RRC reconfiguration complete message that concludes the second inter-CU LTM switch. The process may continue for any number of LTM switches, with the UE 201 using the next NCC from the list for each subsequent LTM switch.

In another aspect of the example embodiments, the example embodiments described above may be extended so that the UE is provided a list of NCCs to use (and use the NCCs in order for each switch, similar to the preceding embodiments described with regard to FIG. 2) and additionally may provide the next NCC value to the target cell and AMF (similar to the preceding embodiments described with regard to FIG. 1). In these example embodiments, the UE provides the NCC value to inform the AMF regarding whether the UE is using the correct NCC. In every RRC reconfiguration complete message, the UE may provide the previous target cell (new source cell) the next NCC the UE intends to use for subsequent LTM switches.

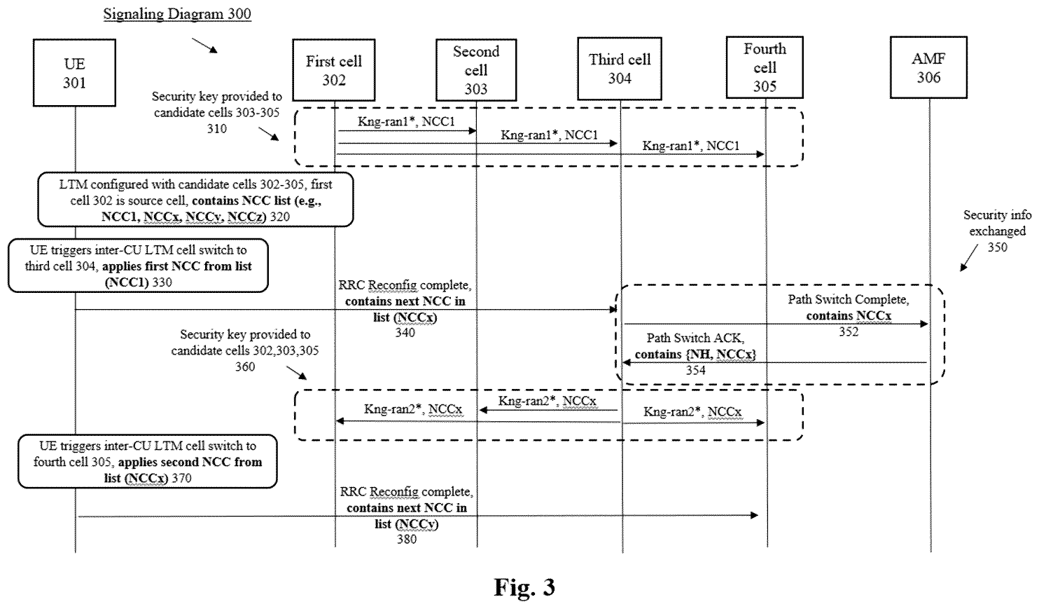

FIG. 3 shows an example signaling diagram 300 for handover from a first cell supported by a first CU to a second cell supported by a second CU (inter-CU handover), the handover being triggered by a UE in a LTM operation, the UE using a NCC value for a handover based on a configured list of NCC values and providing the next NCC value to the AMF, according to various example embodiments. Similar to the preceding embodiments, the signaling diagram 300 is described with regard to security handling for conditional LTM (UE-initiated LTM) with subsequent conditional LTM, e.g., multiple switches without RRC or MAC-CE. The signaling diagram 300 includes a UE 301, a first cell 302, a second cell 303, a third cell 304, a fourth cell 305, and the AMF 306. In this example, the first cell 302 is a current serving cell of the UE 301 and comprises an initial source cell for LTM.

In 310, the first cell 302 distributes security keys to the second cell 303, the third cell 304 and the fourth cell 305 for a UE-initiated LTM switch, similar to 210 of FIG. 2. The security keys are derived from {NH, NCC1} provided to the first cell 302 from the AMF 306. Similar to 210, the first cell 302 derives a single security key, Kng-ran1* from the previous key and NH/NCC1 that may be distributed to all of the cells 303-305 along with the NCC1 in a pre-configuration of the cells 303-305 as candidate target cells for an LTM switch by the UE 301. The NH is not distributed.

In 320, the first cell 302 configures LTM for the UE 301 including the list of candidate cells for LTM (cells 302-305) and a list of NCCs provided to the first cell 302 by the AMF 306, e.g., (NCC1, NCCx, NCCy, NCCz). The UE 301 may derive the security key for a target candidate cell based on the NCCs included in the list in sequential order.

In 330, the UE 301 triggers a first inter-CU LTM cell switch. In this example, the UE 301 triggers the switch to the third cell 304 that satisfied conditional handover conditions. The UE 301 derives the security key for the third cell 304 based on the first NCC entry in the list (NCC1) and applies the configuration for the third cell 304.

In 340, the UE 301 provides a next NCC in the list to the third cell 304, e.g., NCCx. The UE 301 provides the next NCC to inform the AMF 306 (via the third cell 304) of the NCC that the UE 301 intends to use for a subsequent LTM switch (the “next” switch). The next NCC may be provided to the third cell 304 in a RRC reconfiguration complete message that concludes the first inter-CU LTM switch.

In 350, the third cell 304 completes the path switch with the AMF 306 and exchanges security information for the next switch. In these embodiments, the third cell 304 includes the NCCx in the message for a next switch so that the AMF 306 may be informed as to whether the next value to be used by the UE 301 is correct. In 352, the third cell 304 transmits a path switch complete message to the AMF 306 to inform the AMF 306 of the LTM switch and includes in the message the NCCx value indicated by the UE 301. In 354, the third cell 304 receives from the AMF 306 a path switch acknowledgment message including a new NH/NCC pair for deriving the security keys for the next switch, the NH/NCC pair including the NCCx and an associated NH that is based on the NCCx. The third cell 304 may now act as the source cell for a subsequent LTM switch by the UE 301.

In 360, the third cell 304 distributes security keys to the cells 302, 303, 305 for a subsequent UE-initiated LTM switch, similar to 310. The security keys are derived from {NH, NCCx} provided to the third cell 304 from the AMF 306. The third cell 204 derives a single security key, Kng-ran2* from the previous key and NH/NCCx that may be distributed to all of the cells 302, 303, 305 along with the NCCx. The NH is not distributed.

In 370, the UE 301 triggers a second inter-CU LTM cell switch, similar to 330. In this example, the UE 301 triggers the switch to the fourth cell 305 that satisfied the conditional handover conditions. The UE 301 derives the security key for the fourth cell 304 based on the NCCx and applies the configuration for the fourth cell 305.

In 380, the UE 301 provides a next NCC to the fourth cell 305, e.g., NCCy, similar to 340. The UE 301 provides the next NCC to inform the AMF 306 (via the fourth cell 305) of the NCC that the UE 301 intends to use for a subsequent LTM switch (the “next” switch). The next NCC may be provided to the fourth cell 305 in a RRC reconfiguration complete message that concludes the second inter-CU LTM switch. The process may continue for any number of path switches, with the UE 301 using the next NCC from the list for each subsequent path switch and including the next NCC in the RRC reconfiguration complete.

In another aspect of the example embodiments, operations are described for the AMF to re-initialize the security handling. The AMF may choose to re-initialize the security handling for various reasons including, e.g., when exception cases occur. In one example of an exception case, the UE may run out of NCCs in the list. In another example of an exception case, the AMF and the UE may be out of sync with regard to the next NCC to be used. In these example embodiments, the AMF may determine to replace the current list and/or to use a NCC for the next LTM switch different from the NCC indicated by the UE.

In some example embodiments, if a list of NCCs is configured, the AMF may determine that a new list of NCCs should be provided. In other example embodiments, the AMF may determine that a new NCC should be provided. In either case, the AMF may provide the new NCC/list to the new source cell so that the cell may reconfigure the UE with the new NCC/list

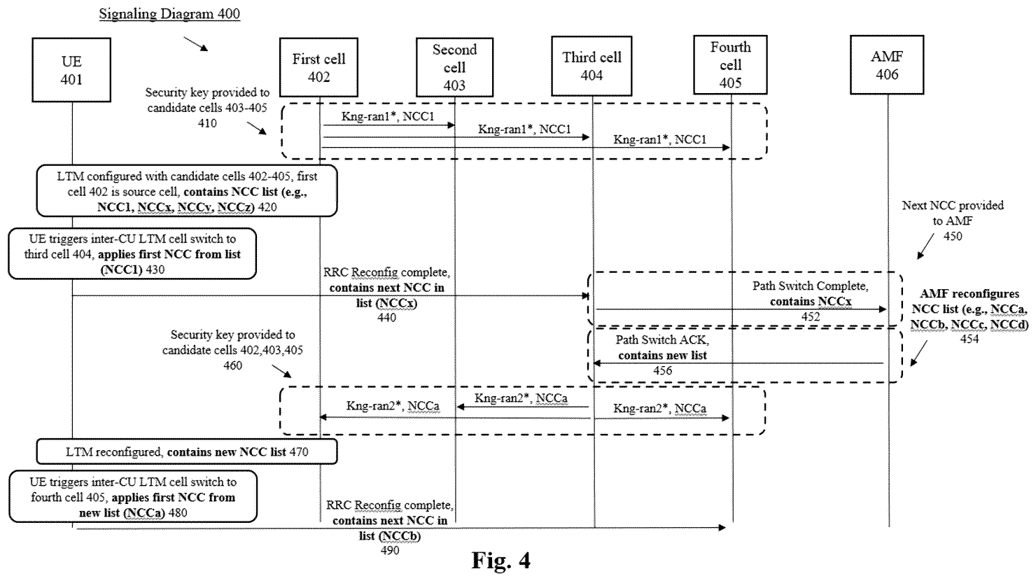

FIG. 4 shows an example signaling diagram 400 for handover from a first cell supported by a first CU to a second cell supported by a second CU (inter-CU handover), the handover being triggered by a UE in a LTM operation, the access and mobility function (AMF) determining to re-initialize the security handling, according to various example embodiments. Similar to the preceding embodiments, the signaling diagram 400 is described with regard to security handling for conditional LTM (UE-initiated LTM) with subsequent conditional LTM, e.g., multiple switches without RRC or MAC-CE. In these embodiments, the security handling is re-initialized by the AMF 406 such that an RRC reconfiguration of the UE 401 is needed to provide the updated security information, e.g., NCC or list of NCCs, to reconfigure the conditional LTM. The signaling diagram 400 includes a UE 401, a first cell 402, a second cell 403, a third cell 404, a fourth cell 405, and the AMF 406. In this example, the first cell 402 is a current serving cell of the UE 401 and comprises an initial source cell for LTM.

In 410, the first cell 402 distributes security keys to the second cell 403, third cell 404 and fourth cell 405 for a UE-initiated LTM switch, similar to 310 of FIG. 3.

In 420, the first cell 402 configures LTM for the UE 401 including the list of candidate cells for LTM (cells 402-405) and a list of NCCs provided to the first cell 402 by the AMF 406, e.g., (NCC1, NCCx, NCCy, NCCz). The UE 401 may derive the security key for a target candidate cell based on the NCCs included in the list in sequential order, similar to 320 of FIG. 3.

In 430, the UE 401 triggers a first inter-CU LTM cell switch to the third cell 404 that satisfied conditional handover conditions. The UE 401 derives the security key for the third cell 404 based on the first NCC entry in the list (NCC1) and applies the configuration for the third cell 404.

In 440, the UE 401 provides the next NCC in the list to the third cell 404, e.g., NCCx. The UE 401 provides the next NCC to inform the AMF 406 (via the third cell 404) of the NCC that the UE 401 intends to use for a subsequent LTM switch (the “next” switch). The next NCC may be provided to the third cell 404 in a RRC reconfiguration complete message that concludes the first inter-CU LTM switch.

In 450, the third cell 404 completes the path switch with the AMF 406 and exchanges security information for the next switch. In these embodiments, the third cell 404 includes the NCCx in the message for a next switch so that the AMF 406 may be informed as to whether the next value to be used by the UE 401 is correct. In 452, the third cell 404 transmits a path switch complete message to the AMF 406 to inform the AMF 406 of the LTM switch and includes in the message the NCCx value indicated by the UE 401.

In this example, the AMF 406 determines that the next value to be used by the UE 401 is not correct or determines to re-initialize the security handling for another reason. In 454, the AMF 406 determines to reconfigure the list of NCCs. In 456, the third cell 404 receives from the AMF 406 a path switch acknowledgment message including a new list of NCCs, e.g., (NCCa, NCCb, NCCc, NCCd). The message may also include a NH/NCC pair including the first entry from the list (NCCa) and a NH based on the NCCa. The third cell 404 may now act as the source cell for a subsequent LTM switch by the UE 401 and may reconfigure the UE 401 with the new list of NCCs.

In 460, the third cell 404 distributes security keys to the cells 402, 403, 405 for a subsequent UE-initiated LTM switch, similar to 410. The security keys are derived based on the first NCC entry (NCCa) in the new list of NCCs provided by the AMF 406 and/or the NH/NCC pair provided by the AMF 406. The NH is not distributed.

In 470, the third cell 404 transmits a LTM reconfiguration to the UE 401 including the new list of NCCs received from the AMF 406. The UE 401 may use the first NCC from the list (NCCa) for a next LTM switch.

In 480, the UE 401 triggers a second inter-CU LTM cell switch to the fourth cell 405 that satisfied conditional handover conditions, similar to 430. The UE 401 derives the security key for the fourth cell 405 based on the first NCC entry in the new list (NCCa) and applies the configuration for the fourth cell 405.

In 490, the UE 401 provides a next NCC in the new list to the fourth cell 405, e.g., NCCb, in a RRC configuration complete message, similar to 440. The UE 401 provides the next NCC to inform the AMF 406 (via the fourth cell 405) of the NCC that the UE 401 intends to use for a subsequent LTM switch (the “next” switch).

If a list of NCCs is not used, the AMF could alternatively provide a new NCC value to the new source cell that could be included by the new source cell in a LTM reconfiguration of the UE.

To facilitate the example embodiments described above, the following UE interface changes may be implemented.

FIG. 5a shows a LTM configuration IE 500 including a first new IE 502 for UE-triggered LTM according to one example of these example embodiments. FIG. 5b shows the UE-triggered LTM IE 502 of FIG. 5a including a second new IE 504 for a NCC list configuration according to one example of these example embodiments. FIG. 5c shows the NCC list configuration IE 504 of FIG. 5b including a third new IE 506 for a NCC list. The NCC list IE 506 may include a sequence of NCC count parameters 508. FIG. 6 shows a RRC reconfiguration complete IE 600 including a new IE 602 for a selected NCC according to one example of these example embodiments.

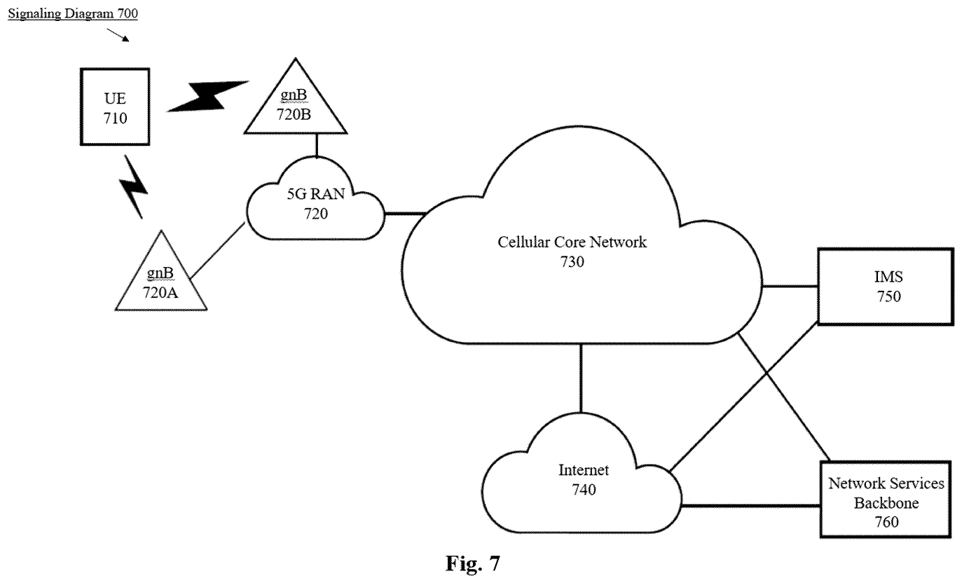

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

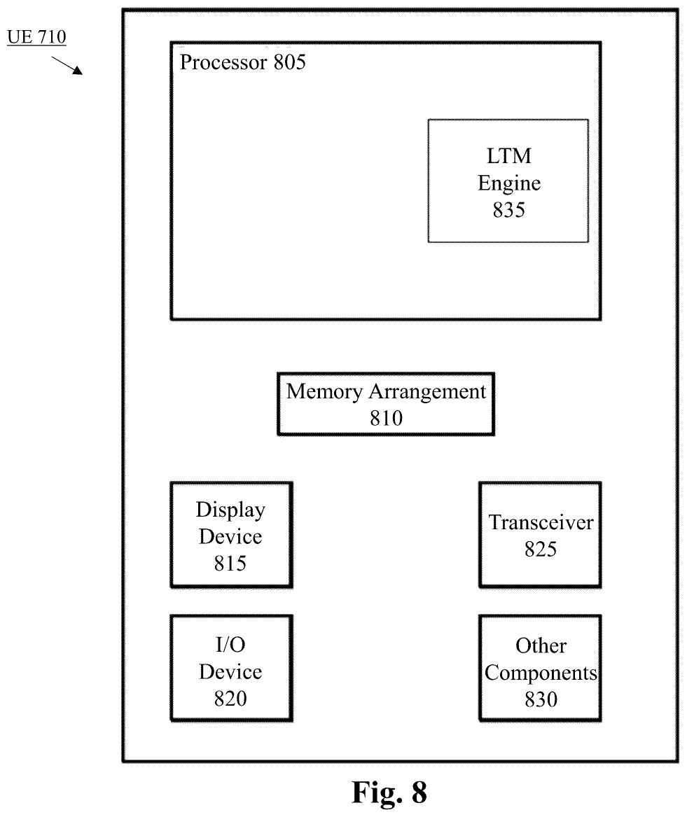

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include a LTM engine 835 for performing operations related to performing a UE-initiated (conditional) LTM switch, as described in detail above.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode and/or decode signals (e.g., signaling from a base station of a network) for implementing any one of the methods described herein.

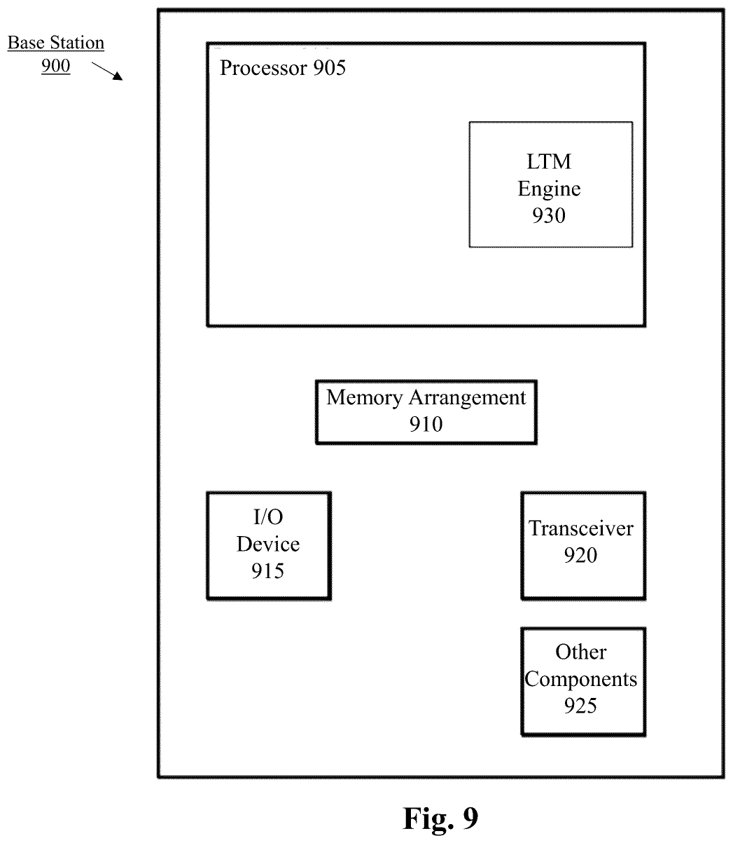

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 900 to other electronic devices and/or power sources, etc.

The processor 905 may be configured to execute a plurality of engines for the UE 710. For example, the engines may include an LTM engine 930 for performing operations related to security handling for a UE-initiated (conditional) LTM switch, as described in detail above.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode and/or decode signals (e.g., signaling from a UE) for implementing any one of the methods described herein.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a first serving cell, a configuration for candidate cells for conditional lower layer triggered mobility (LTM) and a first next hop chaining counter (NCC) value to be used for a first conditional LTM switch;
trigger the first conditional LTM switch to a second serving cell when channel measurements on a second serving cell satisfy a set of handover conditions;
derive a first security key for communications with the second serving cell based on a previous key used for communications with the first serving cell and the first NCC value;
select a second NCC value for deriving a second security key for a second conditional LTM switch after the first conditional LTM switch is completed; and
generate, for transmission to the second serving cell, a message comprising the second NCC value.

2. The apparatus of claim 1, wherein the processing circuitry is further configured to:
trigger the second conditional LTM switch to a third serving cell when channel measurements on the third serving cell satisfy the set of handover conditions;
derive the second security key for communications with the third serving cell based on the first security key and the second NCC value; and
select a third NCC value to be applied to derive a third security key for a third conditional LTM switch after the second conditional LTM switch.

3. The apparatus of claim 1, wherein the message comprising the second NCC value is a radio resource control (RRC) reconfiguration complete message.

4. The apparatus of claim 1, wherein the processing circuitry is further configured to:
process, based on signaling received from the second serving cell, a reconfiguration of a NCC value to be a third NCC value;
trigger the second conditional LTM switch to a third serving cell when channel measurements on the third serving cell satisfy the set of handover conditions; and
derive the second security key for the third serving cell based on the first security key and third NCC value.

5. An apparatus comprising processing circuitry configured to:
derive a first security key for communications with a user equipment (UE) based on a first intermediate security key derived by a first serving cell and a first next hop chaining counter (NCC) value, the first security key to be used for a first conditional lower layer triggered mobility (LTM) switch of the UE;
process signaling from the UE for the first conditional LTM switch, the signaling including a second NCC value used to derive a second security key for a second conditional LTM switch after the first conditional LTM switch is completed; and
generate, for transmission to an access and mobility function (AMF) of a radio network, a message comprising the second NCC value.

6. The apparatus of claim 5, wherein the second NCC value is included in a path switch complete message transmitted to the AMF.

7. The apparatus of claim 5, wherein the processing circuitry is further configured to:
process signaling from the AMF, the signaling including a pair comprising a first next hop (NH) parameter and the second NCC value.

8. The apparatus of claim 7, wherein the pair is included in a path switch acknowledgement message transmitted by the AMF.

9. The apparatus of claim 7, wherein the processing circuitry is further configured to:
distribute a second intermediate security key and the second NCC value to one or more candidate cells to derive the second security key the second conditional LTM switch.

10. The apparatus of claim 5, wherein the processing circuitry is further configured to:
process signaling from the AMF, the signaling including a pair comprising a first next hop (NH) parameter and a third NCC value;
distribute a second intermediate security key and the third NCC value to one or more candidate cells to derive the second security key the second conditional LTM switch; and
reconfigure the UE for LTM including the third NCC value for the second conditional LTM switch.

11. The apparatus of claim 5, wherein the processing circuitry is further configured to:
process signaling from the AMF, the signaling including a list of NCC values to be used for conditional LTM switches;
distribute a second intermediate security key and a first NCC value from the list to one or more candidate cells to derive the second security key for the second conditional LTM switch; and
reconfigure the UE for LTM including the list of NCC values.

12. An apparatus comprising processing circuitry configured to:
process, based on signaling received from a first serving cell, a configuration for candidate cells for conditional lower layer triggered mobility (LTM) and a first list of next hop chaining counter (NCC) values to be used for conditional LTM switches;
trigger a first conditional LTM switch to a second serving cell when channel measurements on the second serving cell satisfy a set of handover conditions;
derive a first security key for communications with the second serving cell based on a previous security key used for communications with the first serving cell and a first NCC value included in the first list of NCC values; and
complete the first conditional LTM switch to the second serving cell.

13. The apparatus of claim 12, wherein the processing circuitry is further configured to:
trigger a second conditional LTM switch to a third serving cell when channel measurements on the third serving cell satisfy the set of handover conditions;
derive a second security key for communications with the third serving cell based on the first security key and a second NCC value included in the first list of NCC values; and
complete the second conditional LTM switch.

14. The apparatus of claim 13, wherein the NCC values in the list are used in sequential order, wherein the first NCC value is a first entry in the list and the second NCC value is a second entry in the list.

15. The apparatus of claim 14, wherein the processing circuitry is further configured to:
generate, for transmission to the second serving cell to inform an access and mobility function (AMF), a message comprising the second NCC value to be used for the second LTM switch.

16. The apparatus of claim 12, wherein the processing circuitry is further configured to:
process, based on signaling received from the second serving cell, a configuration for a second list of NCC values to be used for conditional LTM switches;
trigger a second conditional LTM switch to a third serving cell when channel measurements on the third serving cell satisfy the set of handover conditions;
derive a second security key for communications with the third serving cell based on the first security key and a first NCC value included in the second list of NCC values; and
complete the second conditional LTM switch.
